(19) United States
(12) Patent Application Publication
(10) Pub. No.: US 2013/0055331 A1
(43) Pub. Date: Feb. 28, 2013

(54) SYSTEM AND METHOD FOR VARIABLE VIDEO DEGRADATION COUNTER-MEASURES

(71) Applicant: Bengi KARACALI-AKYAMAC, Bridgewater, NJ (US)

(72) Inventor: Bengi KARACALI-AKYAMAC, Bridgewater, NJ (US)

(73) Assignee: Avaya, Inc., Basking Ridge, NJ (US)

(21) Appl. No.: 13/215,943

(22) Filed: Aug. 23, 2011

(51) Int. Cl. H04N 7/173

(52) U.S. Cl. 725/116

(57) ABSTRACT

Disclosed herein are systems, methods, and non-transitory computer-readable storage media for variable video degradation counter-measures. A system configured according to this disclosure transmits a video communication over a network, detects the video quality degradation of the video communication, selects an appropriate counter-measure based at least in part on the particular type of degradation encountered, and implements the appropriate counter-measure. If multiple transmission paths are available in the system, either completely or partially disjoint, the paths can be evaluated based on ability to deliver video traffic. Throughout the transmission the system continues measuring and monitoring the video quality in real-time. The system can also accurately respond to the type and degree of the degradation by matching the type and degree of degradation to a table containing corresponding counter-measures.

### BACKGROUND

1. Technical Field

The present disclosure relates to adjusting video quality and more specifically to adjusting how video is transmitted based on the degree of detected video degradation using network packet measurements.

2. Introduction

Streaming high amounts of data, and particularly video data, continues to become a prevalent occurrence as society relies more and more upon data networks for communication and business. Because of growing use and reliance upon video transmissions, any tolerances which once existed to degraded video connections are quickly disappearing. Designers of video transmission technologies generally respond to network degradation by decreasing the bit-rate an amount corresponding to the amount of network degradation detected. Video transmissions can be particularly sensitive to network problems such as lost packets, late packets, and out of order arrival of packets.

Unfortunately this response fails to quantify the impact of network degradation on video quality. This failure in turn generally leads to a single response for every type of degradation detected, regardless of how effectively that response will rectify or address that particular form of degradation. For example, video utilizing inter-frame (I-frame) compression eliminates redundancy in a sequence of frames by ignoring the still parts and focusing on the differences between the frames. If packet loss degradation occurs both in video utilizing I-frame compression and video not utilizing I-frame compression, the same level of packet loss may impair video quality at widely varying levels. Decreasing the bitrate could be appropriate for restoring video quality in the non-I-frame compressed video, but ineffective for the I-frame compressed video. Further, various codecs are impacted differently by the same type of network degradation.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for implementing variable video degradation counter-measures. In one embodiment, a system configured according to this disclosure either directly transmits a video communication over a network or monitors a video transmission by some other entity, detects the video quality degradation of the video communication, selects an appropriate counter-measure based at least in part on the particular type of degradation encountered, and implements the appropriate counter-measure or instructs the other entity to implement the appropriate counter-measure. The counter-measures can be applied at a client side, a server side, and/or within the network infrastructure. To accurately determine video quality, measurements can be taken along the network just prior to and during video transmission. Examples of these measurements can include network packet loss and burst loss density. If multiple network paths are available, either completely or partially disjoint, each path can be evaluated separately in terms of its ability to deliver video traffic.

In another embodiment, a system configured according to this disclosure transmits video, and while transmitting measures and monitors the video quality in real-time. If degradation occurs, the system can respond by evaluating the network paths of existing video flows in terms of the video quality currently being delivered and switch to a better performing alternate path. The system can also accurately respond to the type and degree of the degradation by matching the type and degree of degradation to a table containing corresponding counter-measures. For example, if the video quality degradation does not warrant drastic action, the system references the table and sees that for this particular type or degree of degradation only minor changes need to be made. If the system detects multiple forms of degradation, the system can implement multiple concurrent counter-measures corresponding to each particular form of degradation, or alternatively, locates counter-measures for that particular combination of degradation. In this manner the system provides variable counter-measures for video degradation.

For example, if persistent packet loss is detected, the system can reduce the bitrate. If occasional or infrequent packet loss bursts are detected, the system can send one or more additional I-frames rather than reducing the video bitrate. The system can examine the video to insert the additional I-frames, such as by converting an existing delta frame (such as a B-frame, a P-frame, or other types of frames that rely on other frames to reconstruct the frame data) to an I-frame.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example feedback system;

FIG. 3 illustrates an example block diagram of a system embodiment;

FIG. 4 illustrates a variable response table for multiple forms of degradation;

FIG. 5 illustrates a first example method embodiment;

FIG. 6 illustrates a second example method embodiment; and

FIG. 7 illustrates a third example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

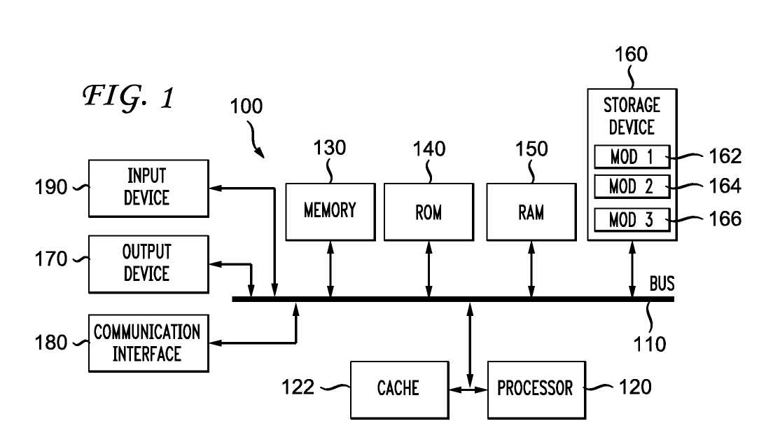

The present disclosure addresses the need in the art for providing variable counter-measures in response to particular degree of video degradation. A system, method and non-transitory computer-readable media are disclosed which measure and analyze the video transmission path, detect degradation during video transmissions, and respond with a measured response particular to the effects of the degradation on the video quality. A brief introductory description of a basic general purpose system or computing device in FIG. 1 which can be employed to practice the concepts is disclosed herein. A more detailed description of variable video degradation counter-measures will then follow. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

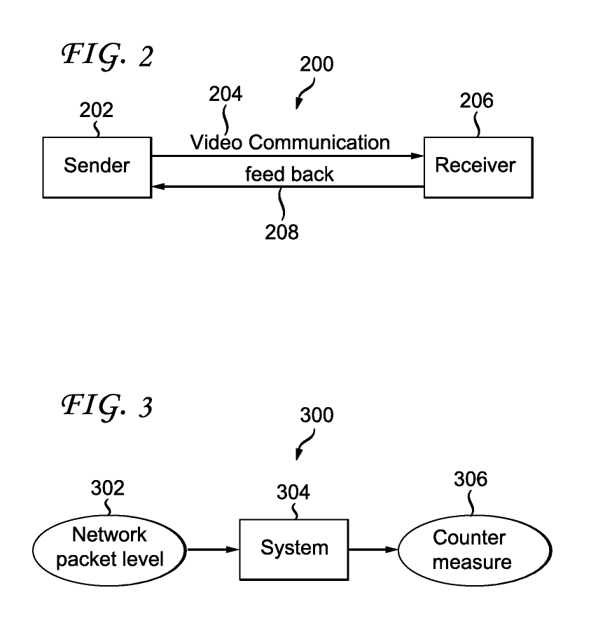

Having disclosed some components of a computing system, the disclosure now turns to FIG. 2, which illustrates an example feedback system 200. The feedback system 200 demonstrates one way in which measurements can be made to determine levels of video quality degradation. A sender 202 transmits a video communication 204 to a receiver 206. The receiver 206, or other source, such as the network or network-based feedback devices, then sends feedback 208 to the sender 202, informing the sender of the video quality. If any degradation is occurring, the sender 202 can then respond. If the sender 202 receives feedback from multiple sources, the sender 202 can average the feedback data, prioritize types of data or sources, or use other data combination techniques to determine what affect the feedback data from the multiple sources has on video quality. Because certain types of video degradation require particular counter-measures, a singular response for all forms of degradation can be inadequate to remedy video quality.

FIG. 3 illustrates an example system embodiment 300. The system 304 receives network packet level measurements 302. The system 304 uses the network packet level measurements 302 to accurately predict video quality. Based on these measurements 302, the system can immediately or a short time thereafter implement corresponding counter-measures 306 if degradation is detected. By using network packet level measurements 302 to determine video quality, rather than awaiting video specific metrics, time can be saved and counter-measures introduced in a more time-efficient manner.

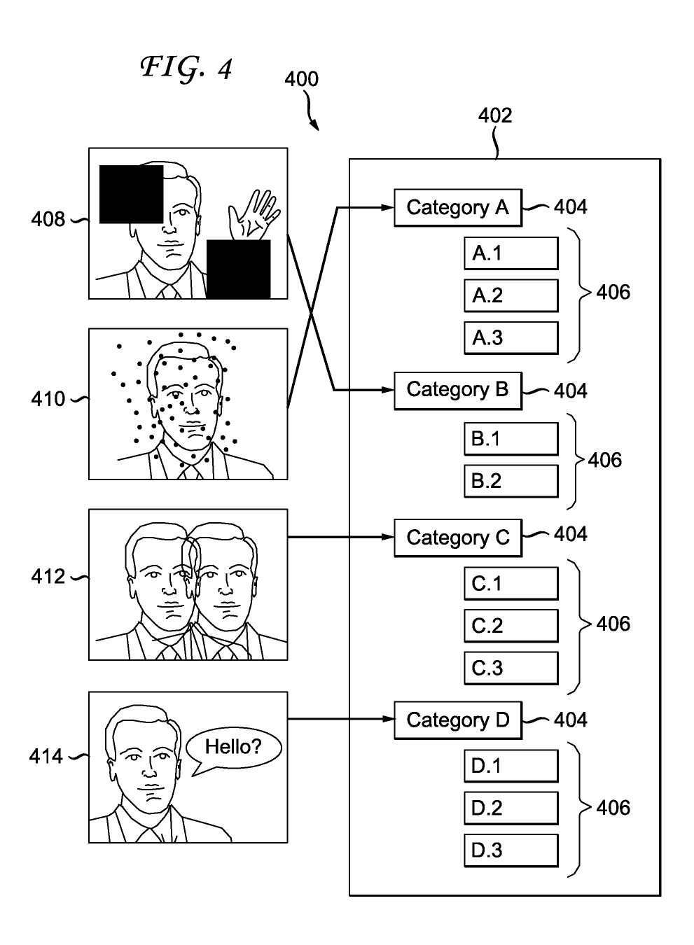

FIG. 4 illustrates an example of a variable response table for multiple forms of degradation 400. Video degradation can be determined from network packet level measurements, processed or unprocessed video quality measurements, feedback from a receiver, and/or other forms of measurement. Video quality measurements intrinsically require quantitative and comparable values, which can be expressed as numbers, alphanumeric data, words, or other data conveyance formats. When video quality measurements are initially received by a system, those measurements are unprocessed, or raw, and can be processed by a computing device to improve the utility of the measurements. For example, a system can receive a video quality measurement of “1001010”, which is then processed and forwarded as “normal”, referring to normal video quality. If the video quality measurements are unprocessed, or insufficiently processed, the measurements can be processed in real-time. Alternatively, certain embodiments can function purely from the unprocessed video quality measurements. The various forms of video degradation 408, 410, 412, 414 each correspond to a category 404 within the table 402. Each category represents counter-measures employable by the system to correct detected video quality degradation. The first form of degradation illustrated, block artifacts 408, represents a noticeable distortion in the video signal and corresponds to category B of the table 402. The second form of degradation, snow or static 410, corresponds to category A. The third degradation form, duplication 412, corresponds to category C, and the fourth degradation form shown, lack of audio 414, corresponds to category D. Other forms of degradation beyond those shown could appear in other embodiments, and in certain embodiments multiple forms of degradation can correspond to a single category of counter-measures.

The various categories 404 each have specific counter-measures 406 depending on the degree, level, or form of degradation detected and can be sorted by codec type, effectiveness, computational or other cost, etc. By way of example, the system 100 can detect degradation in the form of duplication 412, which in the example table 402 corresponds to category C. Within category C are variable counter-measures C.1, C.2, and C.3. A category can include any number of variable counter-measures 406. These variable counter-measures 406 can, for example, increase the bit-rate, reduce the bit-rate, change the codec type, change packet priority, increase or decrease compression, change the network path, or any other remedy to help improve video quality. Counter-measures can modify at least one video parameter, and can modify multiple video parameters. The system establishes these counter-measures for specific levels of detected degradation, and if the detected degradation changes, the specific level of counter-measure can change. Alternatively, the system relies on a previously established table of counter-measures and levels and types of degradation. Similarly, if the degradation ends, the system can end the use of counter-measures. In this manner the system continues to receive measurements concerning the video quality and implement counter-measures 406 specific to the degree and category of degradation detected.

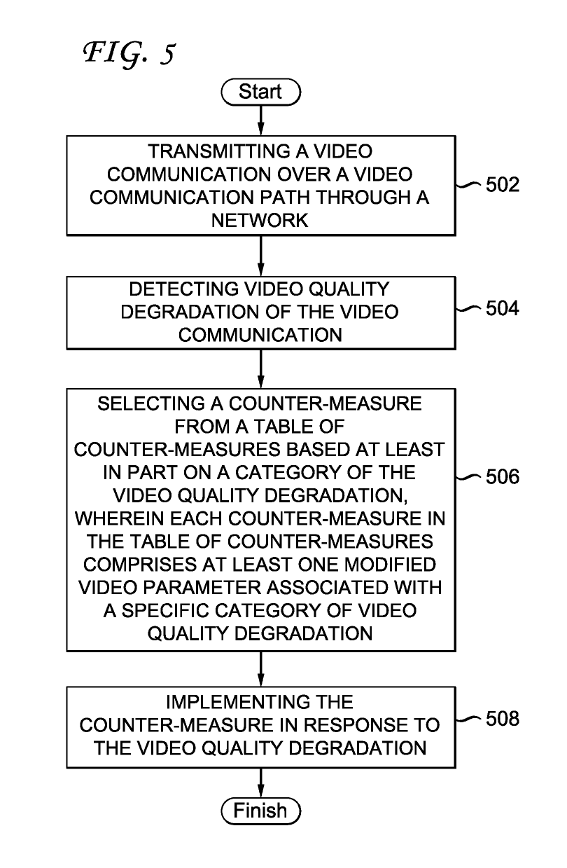

Having disclosed some basic system components and concepts, the disclosure now turns to the exemplary method embodiment shown in FIG. 5. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

A system 100 configured in a manner complying with this disclosure transmits a video communication over a video communication path through a network (502). The video communication can be a conference call, a person-to-person video chat, or other video with low-motion levels encoded as a MPEG-4, Quicktime®, Flash®, or other video format. The system 100 then detects the video quality degradation of the video communication (504) or receives measurements relating to video degradation. This can be accomplished either through feedback from a receiver, by measurements taken by the sender, or by any other entity associated with the video transmission. When degradation is detected, the system 100 selects a counter-measure from a table of counter-measures based at least in part on a category of the video quality degradation, wherein each counter-measure in the table of counter-measures comprises at least one modified video parameter associated with a specific category of video quality degradation (506). The system then implements the selected counter-measure in response to the video degradation (508).

In one aspect, a system 100 configured according to this disclosure can establish baseline values of expected video quality. In certain embodiments, this occurs prior to transmission of the video, whereas in other embodiments the system 100 establishes baselines after video transmission has already begun. To establish baseline values, the system 100 first determines possible paths for the transmission to take. If a single data path exists, this path can then be evaluated in terms such as bandwidth, round-trip communication time, packet loss, degradation, delay, and burst loss density. If multiple paths exist, each individual path can be evaluated by similar measurements. The system 100 can make other measurements as necessary to determine expected effectiveness at transmitting video over a particular path or channel. Such measurements can include network packet level measurements and respective capacities for the one or more paths.

The baselines can be dependent upon the particular video being transmitted or about to be transmitted. For example, a standard definition video would have different baseline levels of degradation than a high definition video. The system 100 can, using the encoding, quality, and other quantifiable data from the video, establish these baselines for a particular video. The system 100 then uses these baselines to create a response table or chart with specific actions for specific levels and types of degradation.

The response table can have different categories of counter-measures for different categories of degradation such as jitter, duplication, delay, and loss of audio. Each of the categories within the response table can have multiple counter-measures for the specific degree of degradation detected. For example, the response table could have multiple counter-measures to degradation stemming from inter-frame compression: a low-level response could decrease the bitrate, a mid-level response could send an I-frame, and a high-level response could change the transmission path to an alternate path if an alternate path is available. The system can select an alternate path at random or can select a specific alternate path that is likely to address the cause of the video degradation.

The system 100 can respond, using the response table, to the detection of multiple types of degradation in several ways. In one embodiment, the system 100 creates a separate category of counter-measures for instances of detection of when multiple forms of degradation. Alternatively, the system 100 can combine the counter-measures from multiple categories to respond to the multiple forms of degradation. For example, if the response table created by the system 100 does not have a pre-formed response to a specific instance of degradation involving both duplication and jitter, the system can combine the individual counter-measures of both the duplication and jitter to form a mixed response.

Once transmission begins, if the system 100 detects degradation matching a specific category, the system 100 can implement a counter-measure associated with that specific category. To detect degradation, the system 100 can continue to make measurements during video transmission. In certain embodiments, the receiving system of the video transmission can independently send feedback to the transmitting system. In other embodiments, the transmitting system can request feedback alongside the video transmission. In yet other embodiments, measurements can occur without direct feedback from the receiver by evaluating total network traffic, capacity, packet loss from similar receivers, and other independent means. The system 100 continues to take the measurements throughout the video transmission, and from those measurements derives degradation of video quality in real time.

Implementation of the counter-measure can occur instantly, or after a designated delay period before implementation. For example, if the system 100 is already implementing various counter-measures and detects a new form of degradation, rather than immediately implementing a new counter-measure the system 100 can wait for verification of the degradation before modifying the current counter-measures. Similarly, if the system 100 monitors multiple streams and detects various forms of degradation, prior to implementing any single counter-measure the system 100 can prioritize the forms of degradation detected, followed by implementing the corrective counter-measures by priority.

FIG. 6 illustrates a second example method embodiment. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

The system 100, based on at least one of video path measurements and desired video quality, establishes baseline video quality values (602). For example, if the video is high definition, baseline degradation values will differ from video degradation values of a standard definition video. Likewise, if the video path from a sender to a receiver has high packet loss as an innate characteristic, baseline degradation values must account for this poor path quality. The system 100 then creates a matrix with types of video degradation corresponding to counter-measures for the types of video degradation, based at least in part on the baseline video quality values. This matrix, or response table, can then be used by the system 100 in providing counter-measures for detected degradation, or used by other computer devices to determine appropriate counter-measures to video degradation.

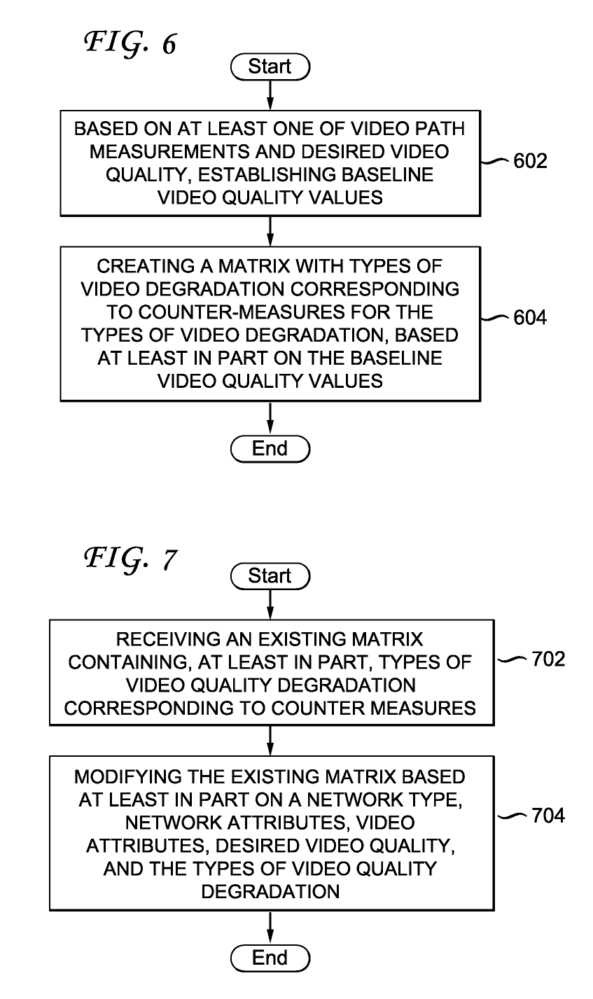

FIG. 7 illustrates a second example method embodiment. As with FIG. 5 and FIG. 6, the method is discussed in terms of an exemplary system 100 as shown in FIG. 1 configured to practice the method. The steps outlined herein are exemplary and can be implemented in any combination thereof, including combinations that exclude, add, or modify certain steps. The system 100 receives an existing matrix containing, at least in part, types of video quality degradation corresponding to counter-measures (702). The system 100 modifies the existing matrix based at least in part on a network type, network attributes, video attributes, desired video quality, and the types of video quality degradation (704). The system 100 can then use the modified matrix to determine counter-measures to video quality degradation. Alternatively, the system 100 can transmit the modified matrix to another computing device, which in turn can use the modified matrix, or table, to implement counter-measures to video degradation.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to all forms and degrees of video degradation. Those skilled in the art will readily recognize various modifications and changes that may be made to the principles described herein without following the example embodiments and applications illustrated and described herein, and without departing from the spirit and scope of the disclosure.

We claim:

1. A method comprising:
transmitting a video communication over a video communication path through a network;
detecting, via a processor, video quality degradation of the video communication;
selecting a counter-measure from a table of counter-measures based at least in part on a category of the video quality degradation, wherein each counter-measure in the table of counter-measures comprises at least one modified video parameter associated with a specific category of video quality degradation; and
implementing the counter-measure in response to the video quality degradation.

2. The method of claim 1, further comprising measuring a quality of service over the video communication path.

3. The method of claim 1, wherein the video quality degradation is determined from at least one of bit error rate, network packet loss, and burst loss density.

4. The method of claim 1, further comprising:
evaluating multiple communication paths through the network; and
transmitting the video communication over one or more of the multiple communication paths.

5. The method of claim 1, wherein at least one counter-measure from the table of counter-measures is at least one of a change in bit-rate and a modification to inter-frame compression encoding parameters.

6. The method of claim 5, wherein the video quality degradation is measured by network packet level measurements.

7. The method of claim 1, wherein implementing the counter-measure in response to the video quality degradation occurs in real time.

8. A system comprising:
a processor; and
a storage device storing instructions for controlling the processor to perform steps comprising:
based on at least one of video path measurements and desired video quality, establishing baseline video quality values; and
creating a matrix with types of video degradation corresponding to counter-measures for the types of video degradation, based at least in part on the baseline video quality values.

9. The system of claim 8, wherein within the matrix there exist a plurality of counter-measures corresponding to each type of video degradation.

10. The system of claim 9, wherein each counter-measure within the plurality of counter-measures corresponds to a degraded video quality based on the baseline video quality values.

11. The system of claim 9, wherein the video degradation is measured by network packet level measurements.

12. The system of claim 8, the instructions for the processor further comprising:
transmitting a video communication over a video path on a network;
receiving measurements related at least in part to a received video quality; and
if a degraded video quality is detected, implementing a specific counter-measure from the matrix.

13. The system of claim 12, wherein the measurements received comprise at least one of bit error rate, network packet loss, and burst loss density.

14. A non-transitory computer-readable storage medium storing instructions which, when executed by a computing device, cause the computing device to perform steps comprising:
receiving an existing matrix containing, at least in part, types of video quality degradation corresponding to counter-measures;
modifying the existing matrix based at least in part on a network type, network attributes, video attributes, desired video quality, and the types of video quality degradation.

15. The non-transitory computer-readable storage medium of claim 14, wherein each type of video quality degradation with the types of video quality degradation corresponds to a plurality of counter-measures.

16. The non-transitory computer-readable storage medium of claim 15, wherein each counter-measure within the plurality of counter-measures corresponds to a specific level of video quality degradation detected.

17. The non-transitory computer-readable storage medium of claim 15, wherein at least one counter-measure within the plurality of counter-measures modifies inter-frame compression.

18. The non-transitory computer-readable storage medium of claim 15, the instructions causing the computing device to perform further steps comprising:
measuring detected video quality degradation.

19. The non-transitory computer-readable storage medium of claim 18, wherein the video quality degradation is measured in at least one of bit error rate, network packet loss, and burst loss density.

20. The non-transitory computer-readable storage medium of claim 14, wherein upon modifying the existing matrix, a first type of video quality degradation and a second type of video quality degradation are modified to become a single category of video quality degradation.
